(19) United States
(12) Patent Application Publication
(10) Pub. No.: US 2006/0006989 A1
(43) Pub. Date: Jan. 12, 2006

(54) Device for warning and protection

(76) Inventor: Peter Holzmann, Lidingo (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/535,356

(22) PCT Filed: Nov. 28, 2003
(86) PCT No.: PCT/SE03/01854

§ 371 Date: May 18, 2005

(51) Int. Cl. B60Q 1/00

(52) U.S. Cl. 340/436; 340/686.1

(57) ABSTRACT

The device (A) is for warning at physical contact of a vehicle with an object in its surrounding and protection of the vehicle at such a contact. The device has a detecting unit (1) and a warning unit (2), where the detecting unit (1) is adapted to be attached to a surface (B) and detect a contact of a vehicle with the detecting unit (1), and where the warning unit (2) is adapted to warn a driver of the vehicle of the detection. The detecting unit (1) consists of a force absorbing plate (11), and an inside the plate (11) acting contact devise (12). A first side (11a) of the plate (11) is adapted to be attached to the surface (B). The plate (11) is given an elasticity adapted to absorb part of the forces that can occur at a contact of a vehicle. The contact device (12) is adapted to close an electric circuit (13) at the contact, and the warning unit (2) is adapted to emit a visual signal and/or an acoustic signal when the electric circuit (13) is closed.

### FIELD OF INVENTION

The present invention consists of a device for warning for physical contact of vehicles with solid objects in its surrounding, as walls, pillars etc., and protection of the vehicle in case of contact, comprising a detecting unit and a warning unit. The detecting unit is adapted to be attached to a surface and detect a contact of a vehicle with the detecting unit, and the warning unit is adapted to warn a driver of said vehicle at said detection.

### DESCRIPTION OF THE BACKGROUND ART

Different means of aid for handling vehicles in narrow spaces are previously known. Those can somewhat simplified be called run-into warning devices and with this should be understood that they are adapted to situations where a vehicle manoeuvres in narrow spaces with a very low speed in connection with e.g. parking, backing up to loading docks etc. There exists in connection with traffic also run-into protections that are adapted to catch vehicles at high speed to minimize damage in connection with accidents. It shall be understood that the invention at hand is of the first sort of run-into warning devices and that run-into means vehicles running into objects at low speed.

This type of run-into warning devices can be divided into different categories.

There exist different devices adapted to help visually in connection with parking.

Publication US 2002/0041239 shows a system where a display shows the position of the vehicle in relation to the space that shall be used for parking.

Publication DE 201 11 974 shows an arrangement of mirrors that provides the driver of a vehicle with a view of the distance between the vehicle and a wall that the vehicle approaches.

There exist also several active distance-warning devices. Those are adapted to measure the distance from a vehicle to surrounding objects and actively warn the driver when the vehicle comes to close to some object. Those types of systems are shown among others in the publications U.S. Pat. No. 6,326,887, U.S. Pat. No. 5,208,586, DE 100 12 788, WO 92/18879 and FR 2 452 721.

There are also a number of known systems based on to physically constitute an obstacle for the tire of a vehicle, where the driver feels this obstacle and stops the vehicle before the driver runs into an object. Those types of systems are shown among others in the publications U.S. Pat. No. 4,641,994, DE 297 19 117, JP 2001-262857 and GB 2 361 752.

There are also systems building on that a device in some way detects a running-into and shows a warning signal to the driver. All of them are adapted to running into them straight from the front, this means in the last phase of a parking e.g. when the driver wants to come as close as possible to a wall with the vehicle. Those types of systems are shown in the publications DE 196 04 963, U.S. Pat. No. 3,261,321, EP 0 014 726, DE 28 44 428, WO 99/27510, U.S. Pat. No. 3,621,807, U.S. Pat. No. 3,977,354 and U.S. Pat. No. 3,820,065.

There are also a number of publications that show how a vehicle is protected mechanically in a garage, those publications show different elastic resistances that are placed in a garage to protect a vehicle when running-into it. Examples of such publications are U.S. Pat. No. 1,496,626, FR 2 773 376, DE 299 16 563 and U.S. Pat. No. 4,161,853.

Finally it is also known to use devices that are adapted to avoid damage of a vehicle at a run-into and at the same time warn the driver.

The publication DE 28 45 683 shows an air-filled rubber cushion where the air in the cushion is pressed out through a whistle when the cushion is subject to compression.

The publication U.S. Pat. No. 3,416,484 shows a device that is adapted to be put around pillars and poles, where an external casing can rotate at a running-into it and where a sound is generated at the rotation of the external casing.

### SUMMARY OF THE PRESENT INVENTION

Problems

Starting with a device for warning at physical contact of vehicles with solid objects in the surrounding and protection of the vehicle at such contact, consisting of a detecting unit and a warning unit, where the detecting unit is adapted to be attached to a surface and detect a contact of a vehicle with the detecting unit, and where the warning unit is adapted to warn a driver of the vehicle at the detection, is it a technical problem to provide a device that easily can be attached to different surfaces, flat as well as e.g. cylindrical surfaces or corners.

It is a technical problem to provide a device that as well warns the driver as protects the vehicle that is running into an object.

It is further on a problem to be able to provide a device that warn not only if the running-into occurs straight from the front against the surface on which the device is attached but also a running-into where the vehicle only touches the device in a direction that is almost parallel with the surface to which the device is attached.

It is a technical problem to be able to provide a device that easily can be adapted to different sizes and different applications, such as for small garages for private cars, parking houses or loading docks for heavy vehicles.

It is a problem to be able to provide a detecting unit that can notice where on the detecting unit the contact has occurred and to indicate this position on the warning unit.

Solution

With the intention to solve one or several of the problems specified above, and with starting-point from a device for warning at physical contact of vehicles and protection of the vehicle at such a contact, comprising a detecting unit and a warning unit, where the detecting unit is adapted to be attached to a surface and detect contact with a vehicle against the detecting unit, and where the warning unit is adapted to warn the driver of the vehicle at the detection, the present invention teaches that the detecting unit comprises a force-absorbing plate, and a with this plate cooperating contact device, where a first side of the plate is adapted to be attached to the surface.

With the intention to protect the running-into vehicle the present invention indicate that the plate is given an elasticity adapted to be able to absorb a part of the forces that can occur at contact with the vehicle.

Further the present invention shows that the contact device is adapted to close an electric circuit at the contact, and that the warning unit is adapted to give a visual signal and/or an acoustic signal when the electric circuit is closed.

According to the present invention the contact device can consist of different types of electric closed circuits, such as e.g. an elastic material that is isolating at normal pressure and is electrically conductive when it is exposed to external pressure or a traditional mechanic contact that is open at normal pressure and closed when exposed to external pressure.

The sensitivity to pressure and elasticity of the detecting unit makes that it also easily can detect a contact of a vehicle that runs into the detecting unit in a direction that is almost parallel with the surface on which the detecting unit is attached, and this without the on-running vehicle being damaged by the contact with the detecting unit.

With the intention not only to be able to indicate that a contact has occurred against a detecting unit but also to point out where on the detecting unit the contact has taken place the present invention teaches that the detecting unit comprises several cooperating contact devices and that those contact devices are positioned in a pattern, such as in a row, or several rows or columns, where the contact devices are electrically connected to different electrical circuits in a way that makes it possible to detect which one of the contact devices that closes an electrical circuit, where the warning unit is adapted to show where on the detecting unit a physical contact has taken place.

With the intention to provide a detecting unit that can be attached to others than flat surfaces the present invention shows that the plate and all or parts of it are provided with one or more notches, placed towards the first side, whereby the detecting unit is adapted to be bent around and attached to not flat surfaces, such as pillars, poles or corners.

It is also possible to make the plat bendable, so that the detecting unit is adapted to be attached to not flat surfaces, such as pillars, poles or corners.

It is further on possible to make the plate in the shape of an angle, whereby the detecting unit is adjusted to be attached around a corner.

With the intention to protect the running-into vehicle the present invention teaches that the total elasticity of the detecting unit is adapted to be able to absorb a part of the forces that can occur at the contact of a vehicle, and that the warning unit is adapted to give a warning signal at such a contact, in a way so that the driver of the vehicle can observe the warning signal before the forces have a damaging influence on the vehicle.

According to the present invention the warning unit may stand in electrical connection with the detecting unit. But there is nothing that prevents that the warning unit stands in wireless connection with the detecting unit hereby making the device more adaptable to different situations. It is e.g. then possible to let the warning device be placed inside a vehicle.

Advantages

The most important advantages connected with the present invention is that a devise according to the invention is simple and inexpensive to produce, it is simple to place in different environments, it can be attached to plane surfaces as well as to pillars, poles, corners or other non-flat surfaces, and it can be adapted to light private cars as well as to heavier vehicles.

### BRIEF DESCRIPTION OF THE DRAWINGS

A device according to the present invention will now be described in detail with reference to the accompanying drawings, in which:

FIG. 1 schematically and very simplified shows a device according to the present invention,

FIG. 2 schematically shows a first embodiment of a contact device,

FIG. 3 schematically shows a second embodiment of a contact device,

FIGS. 4a and b schematically shows different contact bodies in a contact device aiming to giving a contact device springy or elastic properties,

FIG. 5 schematically shows a detecting unit with a number of cooperating contact devices,

FIG. 6 schematically shows a detecting unit adapted to be attached to rounded surfaces, such as pillars or poles,

FIG. 7 schematically shows a detecting unit adapted to be attached around a corner, and

FIG. 8 schematically shows a device with a wireless communication between the detecting unit and the warning unit.

### DESCRIPTION OF EMBODIMENTS AS PRESENTLY PREFERRED

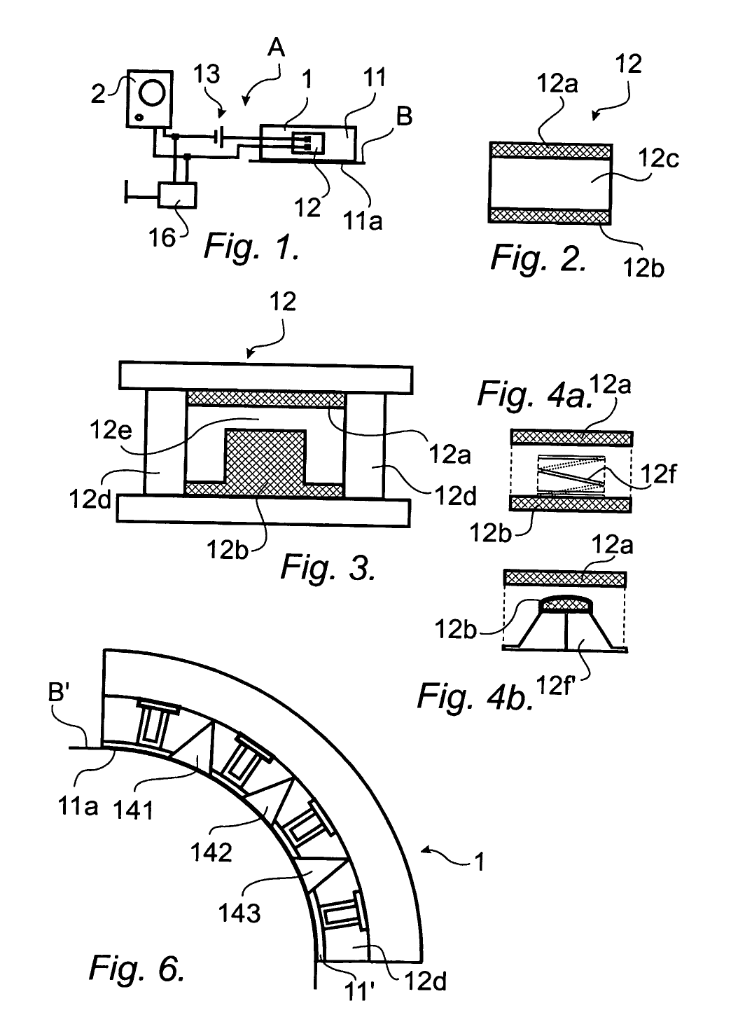

With reference to FIG. 1 is here showed schematically a device A for warning at physical contact of vehicles with solid objects in the environment and protection of the vehicle at such contact.

The device A comprises a detecting unit 1 and a warning unit 2, where the detecting unit 1 is adapted to be attached to a surface B and detect a contact of a vehicle against the detecting unit 1, and where the warning unit 2 is adapted to warn a driver of the vehicle at this detection.

The present invention teaches that the detecting unit 1 comprises a force absorbing plate 11, and a with the plate cooperating contact device 12.

A first side 11a of the plate 11 is adapted to be attached to a surface B, such as a wall in a garage. The plate 11 is given an elasticity adapted to be able to absorb a part of the forces that can occur at a contact with a vehicle.

The contact device 12 is shown in the figure as being enclosed by the plate 11. It must however be understood that that the contact device also can be placed outside the plate or between the plate and the surface to which the plate is attached.

The contact device 12 is adapted to close an electric circuit 13 at a contact, and the warning unit 2 is adapted to give a visual signal and/or an acoustic signal when the electric circuit 13 is closed. It shall be understood that the electrical circuit 13 not in itself must be the circuit that powers the warning unit 2 but that it only needs to be the circuit that indicates that the detecting device 1 has been subject to a contact.

It is possible to use different types of contact devices. According to a preferred embodiment shown in FIG. 2 comprises the contact device an external contact surface 12a, an internal contact surface 12b, and a between those contact surfaces placed elastic material 12c that at normal pressure is electrically isolating and when it is subject to external pressure is electrically conductive. In this way a detecting unit with good elastic properties is achieved.

According to one further preferred embodiment that is shown in FIG. 3 the contact device 12 comprises an external contact surface 12a, an internal contact surface 12b, and an elastic or springy distance 12d, which distance is adapted to at normal pressure produce a gap 12e between the external contact surface 12a and the internal contact surface 12b. The distance 12d is adapted to be compressed when exposed to external pressure, whereby the external contact surface 12a is brought to mechanical and electrical connection with the internal contact surface 12b. In the case when the contact device 12 is completely enclosed by the plate 11 is it normal that the distance 12d is an integrated part of the plate 11.

FIG. 4 shows that the external or internal contact surface 12a, 12b can be given a contact body 12f, adapted to give the contact device 12 elastic or springy properties also in the situation when the contact device 12 is closed.

The present invention indicates that the contact body 12 can be springy or elastically designed. FIG. 4a shows as an example that the contact body 12f can be made of an electrically conducting spring and FIG. 4b shows a contact body 12f′ of elastic material, e.g. rubber, with the contact surface 12b positioned at the end of the contact body 12f′.

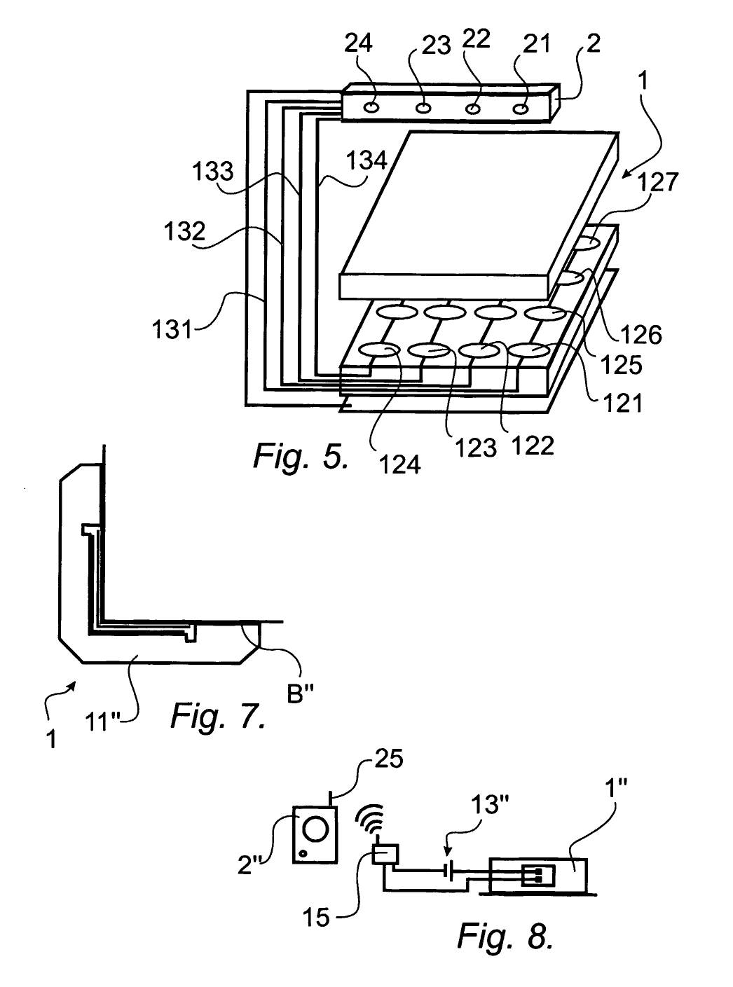

FIG. 5 is made to show a preferred embodiment where the detecting unit 1 comprises a number of cooperating contact devices 121, 122, 123, 124, 125, 126,127. A number of contact bodies 121, 125, 126, 127 can be connected to each other to a common electric circuit 131. It is also possible to let a number of contact devices 121, 122, 123, 124 be positioned in a pattern, such as in a line, or a number of lines or columns, where they are electrically connected to between themselves different electrical circuits 131, 132, 133, 134 in a way that makes it possible to detect which of the contact devices that closes an electric circuit.

In this embodiment the warning unit 2 can be adapted to indicate where on the detecting device 1 a physical contact occurs by means of e.g. different light-emitting means 21, 22, 23, 24 being placed in the warning device 2 in a pattern that is according to the positions of the different contact devices 121, 122, 123, 124 in the detecting unit 1, where each light-emitting mean 21, 22, 23, 24 is adapted to give a light signal when accordingly placed contact device 121, 122, 123, 124 closes its corresponding electric circuit 131, 132, 133, 134.

FIG. 6 shows that the plate 11′ and all or parts of the distances 12d are given one or several, against the first side 11a directed, notches 141, 142, 143, which makes it possible to adapt the detecting unit 1 to be bent around and attached to non-flat surfaces B′, such as pillars, poles or corners.

The present invention shows that the plate can be made bendable, so that the detecting unit can be adapted to be attached to non-flat surfaces, such as pillars, poles or corners in the case that a surface only diverts a little from a flat surface.

FIG. 7 is meant to show an embodiment where the detecting unit 1 is adapted to be attached around a sharp corner B″ by means of that the plate 11″ is given angular shape.

To be able to supply a mechanical protection to vehicles that at low speed comes in contact with an inventive device A shows the present invention that the total elasticity of the detecting unit 1 shall be adapted to be able to absorb part of the forces that can occur at a contact with a vehicle, and that the warning unit 2 shall be adapted to give a warning signal at such a contact, in a way so that a driver of the vehicle can become aware of the warning signal before the forces have a damaging influence on the vehicle.

The detecting unit 1 and the warning unit 2 can communicate with each other by different means. Again referring to FIG. 1 a preferred embodiment is shown where the warning unit 2 stands in electrical connection with the detecting unit 1. In this case can the electrical circuit 13 that is closed by the detecting unit 1 also constitute the electrical circuit that powers the warning unit 2.

According to another preferred embodiment shown in FIG. 8 stands the warning unit 1″ in wireless connection with the detecting unit 2″, here schematically shown by radio emitter 15 and warning unit 2 adapted to receive radio signals via a receiving antenna 25. This embodiment leaves great liberty where the warning unit can be placed. E.g. in this embodiment the warning unit can be placed inside a vehicle.

The present invention is independent of how the electric circuit 13 is powered. It can however be of advantage to let the electric circuit 13 be powered by low-tension current because low-tension current can be handled by a non-professional, hence it follows that everybody can handle and mount a device according to the invention.

FIG. 1 shows that the detecting device 11 as an example can be powered by a battery 13a or by main voltage through a transformer 16. It is also possible to let the battery 13a be emergency power to the main voltage 16. It must be understood that the warning unit 11 can be powered completely separate and independent of the detecting unit 12.

It will be understood that the invention is not restricted to the aforedescribed and illustrated exemplifying embodiments thereof and that modifications can be made within the scope of the inventive concept as illustrated in the accompanying Claims.

1. A device for warning for physical contact of vehicles and protection of the vehicle in case of such a contact, comprising:
a detecting unit in operative engagement with a warning unit,
the detecting unit being attachable to a surface and adapted to detect a contact of a vehicle with the detecting unit,
the warning unit is adapted to warn a driver of the vehicle at the detection,
the detecting unit having a force absorbing plate, and a contact device that cooperates with the force absorbing plate,
a first side of the force absorbing plate being attachable to the surface,
the force absorbing plate having an elasticity adopted to absorb forces that occur during the contact,
the contact device being adapted to close an electric circuit at the contact,
the warning unit being adapted to provide a visual signal and/or an acoustic signal when the electric circuit is closed,
the elasticity of the detecting unit being adapted to absorb forces that occur by the contact,
the warning unit being adapted to provide a warning signal at such a contact so that a driver of the vehicle becomes aware of the warning signal before the forces have a damaging influence on the vehicle.

2. A device according to claim 1, wherein the contact device has an external contact surface, an internal contact surface, and an elastic material is positioned between the contact surfaces, the elastic material is electrically isolating at normal pressure and becomes electrically conductive at external pressure.

3. A device according to claim 1, wherein the contact device has an external contact surface, an internal contact surface, and an elastic or springy distance device, and that the distance device is adapted to, at a normal pressure, keep a distance between the external and internal contact surfaces, and that the distance device is adapted to be compressed when the distance device is subject do external force so that an electrical contact occurs between the external and internal contact surfaces.

4. A device according to claim 3, wherein the external or internal contact surfaces are given a contact body adapted to give the contact device elastic or springy properties also in a situation when the contact device is closed.

5. A device according to claim 4, wherein the contact body is made of an elastic or springy material, the contact surface is situated at an end of the contact body.

6. A device according to claim 1 wherein the detecting unit is made of a number of cooperating contact devices.

7. A device according to claim 6, wherein the contact devices are connected to a common electrical circuit.

8. A device according to claim 6, wherein the contact devices are placed in a pattern, the contact devices are connected to different electrical circuits in a way that makes detection possible of which one of the contact devices that closes an electrical circuit, and that the warning unit is adapted to display on which place on the detecting unit a physical contact occurs.

9. A device according to claim 3 wherein the plate and the entire or parts of the distance is given one or more, against the first side directed, notches, through which the detecting unit is adapted to be bent around and attached to non-flat surfaces.

10. A device according to claim 1 wherein the plate is made bendable so that the detecting unit is attachable to non-plane surfaces.

11. A device according to claim 1 wherein the plate is made in the shape of an angle through which the detecting unit is adapted to be attached.

12. A device according to claim 1 wherein the warning unit stands in electrical connection with the detecting unit.

13. A device according to said claim 1 wherein the warning unit stands in wireless connection with the detecting unit.

14. A device according to claim 13, wherein the warning unit is placed inside a vehicle.

15. A device according to claim 1 wherein the electrical circuit is powered by low power current.
